(19) United States
(12) Patent Application Publication
(10) Pub. No.: US 2024/0284918 A1
(43) Pub. Date: Aug. 29, 2024

(54) INSECT REPELLENT COMPOSITION AND A METHOD OF REPELLING INSECTS

(71) Applicant: Åbo Akademi, Åbo (FI)

(72) Inventors: Senthil Kumar Rajendran, Åbo (FI); Preethy Paul, Åbo (FI); John Eriksson, Åbo (FI); Patrik Eklund, Åbo (FI)

(21) Appl. No.: 18/562,473

(22) PCT Filed: May 20, 2022
(86) PCT No.: PCT/FI2022/050345

§ 371 Date: Nov. 20, 2023

(30) Foreign Application Priority Data
May 20, 2021 (FI) 20215603

(51) Int. Cl. A01N 65/22; A01N 25/02; A01N 25/24; A01N 31/02; A01P 17/00

(52) U.S. Cl. CPC A01N 65/22; A01N 25/02; A01N 25/24; A01N 31/02; A01P 17/00

(57) ABSTRACT

The invention relates to insect repellent compositions, in particular to insect repellent compositions comprising hexahydrofarnesyl acetone (HFA), preferably HFA related substances, and a delivery vehicle. The invention also relates to the use of HFA as an insect repellent. Further objects of the invention are the use of oils and enriched extracts of Anisomeles species as insect repellents, and a method of repelling insects and for preventing diseases caused or transmitted by insects. The insect repellent compositions of the invention can provide a prolonged period of protection to a minimum of 8 hours.

### FIELD

The present invention relates to insect repellent compositions, in particular to insect repellent compositions comprising hexahydrofarnesyl acetone (HFA), HFA related substances or both, in particular HFA, and a delivery vehicle. The invention also relates to the use of HFA as an insect repellent. Further objects of the invention are the use of oils and enriched extracts of Anisomeles species, in particular HFA containing oils and enriched extracts of Anisomeles species, as insect repellents, a method of repelling insects and a method for preventing diseases, in particular infections, caused or transmitted by insects. The invention also relates to insect repellent compositions comprising oils of Anisomeles, enriched extracts of Anisomeles, or both, optionally in combination with added HFA, HFA related compounds or both, and a delivery vehicle.

### BACKGROUND

According to a recent report by Centre for Disease Control and Prevention, vector-borne diseases around the world are increasing (more than 700,000 deaths annually). Especially Borrelia, TBE, Malaria and Dengue in Asian countries, Lyme and West Nile Virus in American and European regions have become a major concern. All these chronic infections are transmitted mostly by ticks and mosquitoes. The natural solution to the reduction of disease incidences is to have a powerful repellent, which would unable the bugs to bite and therefore transmit the disease.

Based on the chemical composition and active ingredients used in ticks and mosquito repellents, insect repellents are divided into natural and synthetic products. All the synthetic repellents in the market are rich in toxic chemicals that can irritate lungs, and also cause asthma-like symptoms and a cough-inducing stretch. They are both dangerous to human health and harmful to the environment. Moreover, they are effective against either ticks or mosquitoes. It is also noted that, compared with mosquitoes, ticks are more difficult to repel.

Synthetic products containing DEET or picaridin sometimes offer only brief protection. IR3535 (3-[N-butyl-N-acetyl]-aminopropionic acid, ethyl ester is a relatively new synthetic repellent recently approved that has shown to be an effective active ingredient. Developed by Merck & Co., IR3535 is an alternative to DEET and provides longer protection. Whilst it is marketed as a “less dangerous” alternative to DEET, it causes eye irritation if the chemical enters a person's eye. In addition, the product, as commonly is a problem, does not repel the nymphs and the female ticks of the Ixodus ricinu species (test results received from Entostudio laboratory, Italy), which is the primary vector for Lyme disease and TBE, as well as several other tick-borne pathogens now so common in Europe and North America.

One problem with the current synthetic repellents is thus that they are not 100% effective on ticks in general, as they do not repel the nymphs and the females of the tick species. Since the synthetic repellents may also be harmful to humans and the environment, the demand for natural insect repellents has significantly increased.

However, most of the commercial natural repellents such as Lemon eucalyptus oil, lavender, cinnamon oil and soybean oil are not effective against ticks and/or mosquitos. Moreover, they typically provide only a short period of efficacy.

In the present invention, we have developed an alternative to toxic chemical repellants and other ineffective natural insect repellents. The novel repellent based primarily on Anisomeles plant oil, in particular Anisomeles malabarica oil, which is rich in hexahydrofarnesyl acetone, or on hexahydrofarnesyl acetone as such, preferably in combination with a refined or enriched extract (derived from the same plants), was found to be very effective against both ticks and mosquitos. This innovative product demonstrates a 100% efficiency in repelling insects (both ticks and mosquitos) compared to other products available in the commercial market.

Some attempts to study the effect of raw Anisomeles plant extracts with parasitic activity against various mosquitoes and ticks have been published. All these publications have studied the effect of the raw extracts on larvae and adult mosquitoes/ticks especially for their insecticidal or mosquitocidal properties to be used in vector control programs. Insecticides are agents that are developed to kill the vectors like mosquitoes and ticks and thus are different from repellents, which only repel the insects and not actually kill them.

Thus Jayakumar et al (2014) studied the larvicidal and synergistic activity of Anisomeles malabarica and Phyllanthus emblica raw extracts against the larvae of malarial vector, Anopheles stephensi Liston. Also Unpaprom et al (2015) found that A. malabarica raw extracts possess mosquito larvicidal properties against the same malarial vector. Crude extracts of A. malabarica showed some acaricidal and insecticidal activity against adults of Haemaphysalis bispinosa Neumann (Acarina: Ixodidae) and hematophagous fly Hippobosca maculate Leach (Diptera: Hippoboscidae) in studies by Zahir et al (2010). Govindarajan et al (2016) have suggested mosquitocidal potential of silver nanoparticles fabricated using Anisomeles indica leaf extract against malaria, dengue and Japanese encephalitis vectors. Demiray et al (2019) and Liu et al (2009) disclose oils from Stachys tmolea and Calycopteris floribunda, respectively, and suggest their use as insecticides.

The chemical composition and antibacterial activity of essential oils from Anisomeles indica and Anisomeles malabarica were investigated by Yogesh and Krishnakant (2011). Antioxidant and antifungal properties of the essential oil of Anisomeles indica have been studied by Kundu et al (2013).

Hexahydrofarnesyl acetone, one of the major components of oil of Anisomeles in the present studies, has been accepted for use as a food additive. Also farnesyl acetone which is usually present in oil of Anisomeles. finds use as a food additive, in particular as a flavoring agent. In addition, US patent publications US2005042244A1 and US2005129752 A1 disclose the use of gaseous farnesyl acetone for controlling Acarina and pests, respectively. However, the use of hexahydrofarnesyl acetone as an insect repellent has not been disclosed or suggested. Neither is there any disclosure or suggestion in prior art that hexahydrofarnesyl acetone found in various plant oils could be responsible for any insecticidal or repellent activity of said oils.

There still exists a need to provide an efficient, safe and environmentally friendly insect repellent that effectively repels all types of ticks and mosquitoes, including nymphs and female ticks.

### SUMMARY OF THE INVENTION

The invention is defined by the features of the independent claims. Some specific embodiments are defined in the dependent claims.

The present invention is based on the finding that oils and enriched extracts of Anisomeles species provide extraordinary insect repelling properties against ticks and mosquitoes. These specific qualities were further enhanced by developing a method of extracting oils from Anisomeles plants and enriching the extracts in relation to certain components of oil. In particular, hexahydrofarnesyl actone (HFA) was found to be effective as an insect repellent.

According to a first aspect of the present invention, there is provided an insect repellent composition comprising an effective amount of hexahydrofarnesyl acetone (HFA), preferably in an amount of 1-50% by weight of the composition, optionally HFA related substances, and a delivery vehicle.

According to a second aspect of the present invention, there is provided use of hexahydrofarnesyl acetone as an insect repellent, preferably for repelling mosquitoes, ticks or both.

According to another aspect of the present invention, there is provided use of oil of Anisomeles species as an insect repellent, wherein said oil comprises at least hexahydrofarnesyl acetone (HFA), preferably HFA and HFA related substances.

According to a further aspect of the invention, there is provided an insect repellent composition comprising an effective amount of oil of Anisomeles species, and a delivery vehicle, wherein said oil comprises hexahydrofarnesyl acetone (HFA), preferably HFA and HFA related substances.

Further aspects of the present invention include articles of manufacture that have been treated or impregnated with a composition according to the invention.

Another aspect of the present invention is to provide a method of repelling insects or a method for preventing infections caused or transmitted by insects, wherein said methods comprise administering topically on the skin or clothing of a subject an effective amount of an insect repellent composition according to the invention or wearing or using an article of manufacture according to the invention.

Considerable advantages are achieved by the invention. First, hexahydrofarnesyl acetone as well as the oil and enriched extract of Anisomeles have been found to be very effective against insects, typically ticks and mosquitoes. In particular, compositions comprising hexahydrofarnesyl acetone, Anisomeles oil, enriched extract of Anisomeles, or combinations thereof demonstrated a 100% efficiency in repelling both ticks and mosquitos up to 8 hours, thus achieving better and significantly longer protection than commercially available products. Moreover, hexahydrofarnesyl acetone, as well as HFA containing Anisomeles oil and enriched extract do not repel only male ticks but also nymph and female ticks, which effect has not been achieved by other repellents.

Second, hexahydrofarnesyl acetone, HFA containing Anisomeles oil, enriched Anisomeles extract or their combinations provide a natural, effective and environmentally friendly alternative to toxic chemical repellents and ineffective natural insect repellents.

Third, the insect repelling effects of HFA, Anisomeles oil and enriched Anisomeles extract find use in preventing diseases, in particular infections, caused or transmitted by insects.

Hexahydrofarnesyl acetone, Anisomeles oil, the enriched extract and combinations thereof can be included in different formulations, such as sprays, creams, lotions, gels, roll-ons, and vaporizers. Moreover, advantageously certain articles or manufacture, such as textiles and equipment for humans and animals, such as jackets, T-shirts, sweaters, socks, caps, and trousers; shoes, mosquito nets, dermal wipes, and the like can be treated or impregnated with hexahydrofarnesyl acetone, Anisomeles oil, Anisomeles enriched extract, their combinations or formulations containing the same, to protect the users from insects.

Further features and advantages of the present technology will appear from the following description of some embodiments.

### BRIEF DESCRIPTION OF THE DRAWINGS

FIG. 1A illustrates GC-FID chromatogram of oil of Anisomeles malabarica; FIG. 1B illustrates GC-MS chromatogram of oil of Anisomeles malabarica;

FIG. 2 illustrates the study design for tick repellent testing;

FIG. 3 illustrates mosquito repellent activity of oil of Anisomeles; and

FIG. 4 illustrates tick repellent activity of oil of Anisomeles during live study.

FIG. 5 shows repellent activity results from a field test wherein a treated tick sheet was dragged in a tick-friendly biotope.

### EMBODIMENTS

Hexahydrofarnesyl acetone (C₁₈H₃₆O) (synonym 6,10,14-trimethyl-pentadecanone) is an isoprenoid ketone (sesquiterpene), which may be isolated from several plants or obtained by known synthesis methods, for example by hydrogenation of farnesyl acetone. Hexahydrofarnesyl acetone (HFA) has antibacterial, anti-nociceptive and anti-inflammation activities. Moreover, HFA has been accepted for use as a food additive. The structure of HFA is shown below (Formula I).

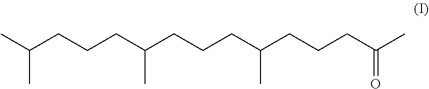 [SMILES: CC(=O)CCCC(C)CCCC(C)CCCC(C)C]

In the present context, HFA related substances or HFA related compounds typically include farnesyl acetone.

Farnesyl acetone (C₁₈H₃₀O) is a terpene ketone in which an (E,E)-farnesyl group is bonded to one of the alpha-methyls of acetone. The structure of farnesyl acetone is shown in Formula II below. Like hexahydrofarnesyl acetone, farnesyl acetone has been accepted for use as a food additive, in particular as a flavoring agent.

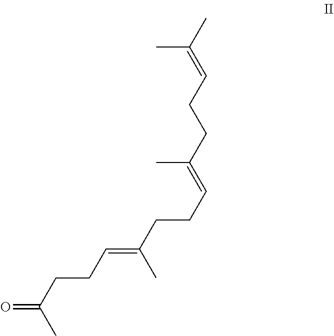 [SMILES: CC(=O)CC/C=C(\C)CC/C=C(\C)CCC=C(C)C]

Anisomeles species typically include A. malabarica, A. indica or A. ovata or combinations thereof. A preferred Anisomeles species is A. malabarica.

In the present context, an “enriched” or “refined” extract of Anisomeles refers to an extract of Anisomeles, preferably obtained as disclosed herein, wherein the composition of the extract is concentrated, i.e. enriched, for certain compounds, at least for HFA, preferably for HFA and HFA related compounds, such as FA. “Concentration” typically covers e.g. the option of removing other components from the composition containing HFA or HFA related compounds or both, thereby increasing the concentration of HFA, HFA related compounds or both, and the option of separating and recovering HFA and HFA related compounds from the composition.

In one embodiment, the invention relates to insect repellent compositions comprising an effective amount of hexahydrofarnexyl acetone (HFA), HFA related substances, or both, and a delivery vehicle. In a preferred embodiment, the insect repellent composition comprises an effective amount of HFA.

As used herein, the term “effective amount” refers to an amount which, when administered in a proper dosing regimen, is sufficient to repel insects from the vicinity of the human or animal using or applying the composition of the invention or an article of manufacture comprising the same. The repellent effect may occur by administration of one dose, and a continuous repelling effect may occur after administration of a series of doses. Thus, an effective amount may be administered in one or more administrations per day for successive days, if needed.

Typically, the insect repellent composition comprises at least 1% of HFA. HFA related substances or both, more typically at least 5%, even more typically at least 10% by weight of the composition. Preferably, HFA, HFA related substances or both are present in an amount of about 1-50%, preferably 5-50%, such as 5-40%, more preferably 10-50%, such as 10-40%, by weight of the insect repellent composition.

An effective amount of HFA is preferably 1-50%, preferably 5-40%, by weight of the composition. In one embodiment, the insect repellent composition comprises an effective amount of HFA, which is at least 5%, preferably at least 10%, such as 5-20%, or 10-30% by weight of the composition. In one embodiment, the insect repellent composition comprises an effective amount of HFA, which is 10-50% or 10-40% by weight of the composition. In further embodiments, the insect repellent composition comprises an effective amount of HFA, which is 15-50%, 20-40% or 20-30% by weight of the composition. In preferred embodiments, the insect repellent compositions comprise HFA as the main active ingredient.

According to one embodiment, the HFA related substances comprise farnesyl acetone, preferably in an amount of at least 1% of farnesyl acetone, more preferably at least 5%, by weight of the composition. In one embodiment, farnesyl acetone is present in an amount of 5-40%, preferably about 5-30%, more preferably 5-20%, by weight of the composition.

The HFA related substances, such as farnesyl acetone, are present in the compositions in combination with HFA. The combined amount of HFA and FA in such an insect repellent composition is typically at least 5%, preferably at least 10%, more preferably at least 20% by weight of the composition.

In some embodiments of the invention, fixative agents may be included in the insect repellent composition. A typical example of known fixative agents for insect repellent compositions is vanillin, which is used as a fixative agent for example in insect repellent compositions comprising p-methane-3,8-diol (WO 2017/081445 A1). Vanillin is reported to extend the repellency duration of the repellent. Other fixative agents include but are not limited to Glucam P-20, Fixolide and Salicyluric acid.

The insect repellent compositions of the invention comprise a suitable delivery vehicle or carrier, which facilitates the use and release of the active agents of the composition. Typically, the delivery vehicle or carrier comprises at least water and at least one aliphatic alcohol. In some embodiments, the compositions may be included in containers or release devices with varying shapes and/or sizes for indoor or outdoor use.

In one embodiment, the repellent agents may be included in an aerosol spray formulation, which typically includes at least one aliphatic alcohol and which may be sprayed in the air, on the ground or on clothing, for example.

In another embodiment, the repellent agents may be included for example in a cream or gel base, which includes at least one aqueous aliphatic alcohol, in combination with conventional ingredients typically included in cream or gel bases. Conventional cream or gel bases are typically emulsions of water and oil, containing for example emulsifiers, humectants, thickeners and preservatives. Other suitable formulation types include lotions, roll-ons, vaporizers or the like, as known to persons skilled in the art.

The invention is also directed to the use of hexahydrofarnesyl acetone as an insect repellent. The invention further relates to the use hexahydrofarnesyl acetone containing oil of Anisomeles species as an insect repellent.

### Oil of Anisomeles

In previous studies, oils of Anisomeles species have been found to comprise dozens of compounds (Kundu et al, 2013; Yogesh and Krishnakant, 2011). The major components identified herein in the oil of Anisomeles malabarica include hexahydrofarnesyl acetone, 2-phenylethanol, farnesyl acetone, Cembrene A, caryophyllene oxide, hyacinthin, 1,1,2,3,3,-pentachloropropane and humelene oxide.

In the present invention it has been found that the insect repellent activity of oil of Anisomeles is particularly related to hexahydrofarnesyl acetone. Also HFA-related substances, such as farnesyl acetone, may contribute to the insect repellent activity of Anisomeles oil.

In the present invention, the oil of Anisomeles species is typically obtained by a method comprising the steps of extracting plant material of the Anisomeles species by hydrodistillation, collecting the aqueous phase, separating the oil components by using an organic solvent, preferably chloroform, and recovering the oil of Anisomeles.

Thus one embodiment of the invention is an insect repellent composition comprising an effective amount of oil of Anisomeles species, and a delivery vehicle, wherein said oil comprises hexahydrofarnesyl acetone (HFA), preferably together with HFA related substances.

In one embodiment the oil of Anisomeles species is present in an amount of at least about 5%-about 50% by weight in an insect repellent composition which comprises a delivery vehicle, preferably in an amount of at least 10%, such as 10-20%, by weight of said composition.

The oil of Anisomeles may also be used in combination with added hexahydrofarnesyl acetone, farnesyl acetone or both as an insect repellent. In the present context, “added” refers to commercially available, purified forms of the respective compounds.

Typically, added HFA, added farnesyl acetone or both are present in an amount of at least 1%, preferably at least 5%, such as 5-50%, more preferably 5-40% by weight of the composition.

### Enriched Extract

In one embodiment, the oil of Anisomeles species is used in combination with at least one enriched or refined extract of Anisomeles species as an insect repellent, wherein the enriched/refined extract comprises HFA, HFA related substances or both.

The enriched or refined extract is preferably obtained as disclosed in WO 2020/254726 A1. In short, the enriched extract is obtained by extracting Anisomeles plant material with an alcoholic, for example an aqueous alcoholic, or ether solvent, preferably in the presence of activated carbon or by treating the obtained extract with activated carbon. Typically, the delivery vehicle used in the insect repellent composition is at least partly different from the solvent used for extraction of the Anisomeles plant material.

In one embodiment, the enriched extract is present in an amount of at least 3%, preferably 3-10%, more preferably 5-15%, by weight in an insect repellent composition, which comprises a delivery vehicle. The enriched extract preferably contains about 8 to 10% of plant material/extractives.

In some embodiments, the use of oil of Anisomeles species in combination with the enriched extract of Anisomeles is further combined with the use of added (commercial) hexahydrofarnesyl acetone, farnesyl acetone or both.

Preferably, the oil, or the combination of oil and enriched extract, optionally combined with added HFA, FA or both, are formulated in an insect repellent composition, which comprises a delivery vehicle.

In one embodiment the insect repellent composition comprises 5-50% of oil of Anisomeles and 3-10% of enriched or refined extract from Anisomeles species, calculated by weight of the composition,

In another embodiment, the insect repellent composition comprises 5-50%, preferably 5-40% of oil of Anisomeles and 1-50%, preferably 5-40% of added HFA, FA or both, calculated by weight of the composition, optionally in combination with the enriched extract.

The delivery vehicle comprises water and at least one alcohol. Preferably the delivery vehicle is an aqueous aliphatic alcohol or a cream or gel base comprising aqueous aliphatic alcohol. Typically, the composition is a spray, lotion, cream, gel, roll-on or a vaporizer, more preferably a cream, gel or spray.

In one embodiment, the invention relates to use of HFA as an insect repellent, wherein HFA, optionally with farnesyl acetone, is present in an amount of at least 1%, preferably at least 5%, such as 5-50%, more preferably 5-40% by weight in an insect repellent composition, which comprises a delivery vehicle.

In an embodiment, the absolute amount of hexahydrofarnesyl acetone in the insect repellent compositions of the invention is at least 5%, preferably at least 10% by weight of the composition. In some embodiments, the absolute amount of hexahydrofarnesyl acetone in the insect repellent composition may be at least 15%, or at least 17%, or at least 20%, such as 15-50%, 15-40%, 17-50%, 17-40%, 20-50% or 20-40%.

As stated above, the compositions and methods of the invention are effective in repelling insects. The compositions of the invention show repellent activity against various insects, including but are not limited to mosquitoes, ticks, fleas, cockroaches, bugs, ants and flies, including deer flies or elk flies, typically mosquitoes and ticks, particularly ticks, more particularly female ticks, male ticks and nymph ticks, still more particularly female ticks and nymph ticks.

The invention also relates to articles of manufacture, which have been treated or impregnated with any one of the compositions of the invention. Typically such articles of manufacture include textiles and equipment for humans and animals, such as jackets, sweaters, T-shirts, socks, caps, and trousers; shoes, mosquito nets, dermal wipes, and the like.

Another embodiment of the invention is a method of repelling insects, wherein the method comprises administering topically on the skin or clothing of a subject an effective amount of an insect repellent composition of the invention or wearing or using an article of manufacture treated or impregnated with an insect repellent composition of the invention.

A further embodiment of the invention is a method of preventing infections caused or transmitted by insects, wherein the method comprises administering topically on the skin or clothing of a subject an effective amount of an insect repellent composition of the invention or wearing or using an article of manufacture treated or impregnated with an insect repellent composition of the invention.

Embodiments of the invention also comprise the insect repellent compositions and the articles of manufacture for use in the above-mentioned methods.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

### Experimental

Unless otherwise stated herein or clear from the context, any percentages referred to herein are expressed as percent by weight based on a total weight of the respective composition. As used herein, the term “about” refers to a value which is +5% of the stated value

Extraction of Oil from Anisomeles Species

The dry and powdered leaf part of Anisomeles species (collected from southern part of India) was subjected to hydro-distillation for 3 to 4 h (Rassem et al, 2016). The aqueous phase was collected and the components present in the aqueous phase were separated with chloroform using a separating funnel and then dried over anhydrous sodium sulphate. The yellowish-brown color oil of Anisomeles was obtained (0.6%, v/w on dry weight basis) after evaporating the chloroform and it was stored at 4° C. until further used for analysis.

Extraction of a Refined Extract from Anisomeles Species

The isolation and the identification of compounds present in the enriched or refined extract from Anisomeles species (malabarica/indica) was done as reported in co-pending patent application (WO 2020/254726 A1).

Briefly, leaves from Anisomeles malabarica were stirred for 24 h with 2-propanol or MTBE, then activated carbon (10% based on the plant material) was added and the mixture was stirred for additional 24 h. Then the mixture was filtered and the solvent removed. Alternatively, the extraction was performed in the presence of activated charcoal (10% of activated charcoal compared to weight of the plant material). As a result, 9% extractives were obtained as yellow oil. For further enrichment of the extract, the residue was dissolved in methanol and extracted with n-hexane to give yellow solid after solvent removal (8% of the plant material).

Chemical analysis of oils of Anisomeles

The identification of compounds present in the oils of Anisomeles was analysed by GC (Agilent Technologies, model 6850, Santa Clara, USA) with flame ionization detection (FID) (GC-FID) (Clarus 500; Perkin-Elmer Inc., Waltham, MA) on an HP-1 and an HP-5 column (both 25 m×0.2 mm i.d., 0.11 μm film thickness) and mass spectrometer (GC-MS) (Agilent Technologies 7890A+5975C). A small amount of the dry oil was transferred with a Pasteur pipette to a GC vial. Diethylether, 1.5 ml, was immediately added, and the vial was sealed until injection into GC-FID and GC-MS. The GC oven temperature both in GC-FID and GC-MS started from 60° C. The solution was evaporated to dryness using N₂ gas, dissolved in pyridine-BSTFA-TMCS 20:80:20 (v/v/v), and kept at 70° C. for 30 min. The solution was transferred to a glass insert which was then placed in the vial, and 1 μl was injected into the two GC-FIDs containing long and short columns, respectively (for quantification). Ca. 1 μl was also injected into a GC-MS for identification of the compounds. The compounds eluting close to the IS acid 21:0 (i.e., all that elute on long column) should be quantified against this IS. The quantification of the compounds was performed on the basis of GC peak areas.

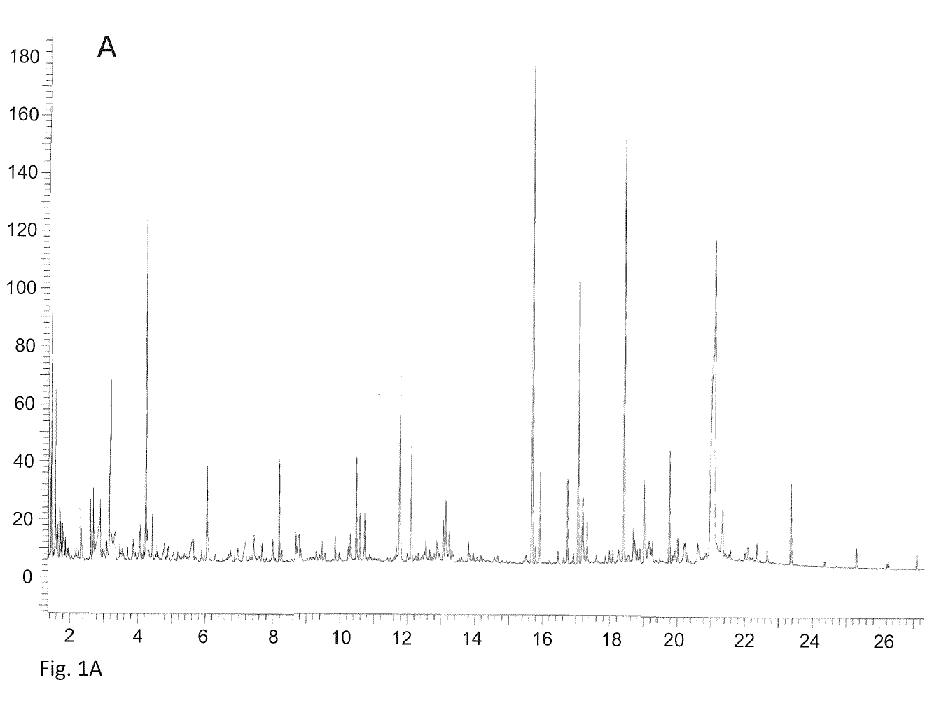

Based on the GC-FID and GC-MS data (FIG. 1), the list of compounds detected in the oil components derived from Anisomeles malabarica is shown in Table 1. From all the identified compounds, Hexahydro farnesyl acetone, 2-Phenylethanol, Farnesyl acetone, Cembrene A, Caryophyllene oxide, Hyacinthin, 1,1,2,3,3-Pentachloropropane, and Humulene oxide represented the major components.

TABLE 1
Chemical composition of oil of Anisomeles

| Compound | Composition %) |
|---|---|
| Styrene | 0.29 |
| Benzaldehyde | 0.75 |
| 1-Octen-3-one | 0.60 |
| 1-Octen-3-ol | 0.88 |
| Hexanoic acid | 0.58 |
| Alpha-pinene | tr |
| Hyacinthin | 2.66 |
| cis-linaloloxide | 0.15 |
| 2-Phenylethanol | 5.04 |
| 1,1,2,3,3-Pentachloropropane | 2.68 |
| Camphor | tr |
| Beta-cyclocitral | 1.07 |
| 4-Vinylphenol | 1.72 |
| Alpha-thujone | tr |
| 3,3-Dimethyl-2,7-octanedione | 0.72 |
| 4-Vinylguaiacol | 0.43 |
| Nonanoic acid | 0.44 |
| Eugenol | 1.36 |
| Beta-damascenone | 0.79 |
| Caryophyllene | 0.26 |
| Gernylacetone | 0.32 |
| Humulene | 0.10 |
| Terpenyl acetate | tr |
| Beta-ionone | 0.36 |
| Dihydroactinidiolide | 1.62 |
| Caryophyllene oxide | 3.52 |
| Humulene oxide | 1.88 |
| Borneol | tr |
| Vanillic acid | 1.21 |
| Tetradecanoic acid | 0.54 |
| Dibutyl phthalate | 0.18 |
| Hexahydro farnesyl acetone | 8.79 |
| Farnesyl acetone | 4.59 |
| Cembrene A | 7.01 |
| Hexadecanoic acid | 1.59 |
| Manoyl oxide | 0.48 |
| bis(ethylhexyl)phthalate | 1.39 |
| Squalene | 0.30 |

tr—trace amount

### Mosquito and Tick Repellent Activity

The mosquito and tick repellency of our tested samples was performed with and/or without formulations (Table 2). The test formulation used in this study was 70% ethanol/gel/cream and the ingredients used to prepare the gel/cream are shown in Table 2.

TABLE 2
Ingredients used for the composition of
repellent formulation (cream and/or gel)

| Ingredients | Use |
|---|---|
| Oil and/or Enriched extract from | Active insect repellent |
| Anisomeles species | |
| Carbopol 934 | Thickener |
| Propylene glycol | Humectant, Emollient |
| Glycerol | Humectant, Emollient |
| Stearic acid | Emulsifier |
| Stearyl alcohol | Coemulsifier |
| Glyceryl monostearate | Emulsifier |
| Isopropyl myristate | Occlusive agent |
| Cetyl alcohol | Thickener, Coemulsifier |
| Propyl paraben | Oil soluble preservative |
| Methyl paraben | Water soluble preservative |
| Aqua | — |

### Study Design for Mosquito Repellent Testing

The mosquitos used in this study were Aedes albopictus. Mosquito repellent activity of the tested samples (listed in Table 2) was assessed by using the test cage as described by Songkro et al (2012), in the American Society for Testing and Materials (ASTM) standard E951-83 Laboratory testing of non-commercial mosquito repellent composition on the skin. The sample was tested on human subject. The same volunteers tested all the formulations under laboratory conditions. According to the method described by Coucci and Müller (2018), 50 adult female Aedes albopictus mosquitoes were transferred into the mosquito proof enclosed cage with the help of aspirator tube. The compositions to be tested were applied to the forearm (25 cm) of the volunteers. The applied hand was introduced into the cage and the number of bites was recorded. After every 30 minutes the volunteer hands were subjected to the cage for 5 minutes and the numbers of mosquito bites were noted. Same procedure was implemented for control. Control study is done by placing the forearm in cage without application of tested sample. Before starting each replication, the mosquitoes' propensity to bite is assessed by inserting an untreated forearm into the cage. The replication can initiate only if at least 10 attempts to bite occur in 30 seconds. According to this procedure different compositions were tested by applying on the forearm with fresh mosquitoes every time of testing. The Percentage protection provided by repellent cream can be expressed by the formula % Repellency=[(No. of bites on Control arm−No. of bites on treated arm)/No. of bites on Control arm]*100.

TABLE 3
Mosquito repellent activity of various percentage combinations of oil of
Anisomeles and/or refined extract with or without formulations

| | Percentage Protection Time | | | | | | | | |
|---|---|---|---|---|---|---|---|---|---|
| Active repellent substances | 0 hr | 1 hr | 2 hr | 3 hr | 4 hr | 5 hr | 6 hr | 7 hr | 8 hr |
| 10% Raw extract (Anisomeles species | 48.8% | 30.2% | 12.8% | — | — | — | — | — | — |
| (malabarica/indica) in 70% Ethanol | | | | | | | | | |
| 10% Refined Extract (Anisomeles species | 54% | 47% | 44.3% | 25.6% | — | — | — | — | — |
| (malabarica/indica) | | | | | | | | | |
| 10% Refined Extract in a formulated cream/gel | 99.2% | 97.8% | 84.8% | 80.5% | 88% | 76.9% | 42% | — | — |
| 10% Oil of Anisomeles in 70% Ethanol | 90.5% | 87.1% | 79.2% | 65.7% | 60.8% | 48.9% | — | — | — |
| 5% Oil of Anisomeles + 5% Refined Extract (5%) | 93.5% | 88.1% | 73.4% | 70.1% | 67.6% | 54.3% | — | — | — |
| in 70% Ethanol | | | | | | | | | |
| 8% Oil of Anisomeles (8%) + 2% Refined Extract | 94.5% | 92.1% | 86.6% | 83.6% | 79.9% | 68.4% | 57.1% | — | — |
| in 70% Ethanol | | | | | | | | | |
| 8% Oil of Anisomeles + 2% Refined Ext. | 100% | 99.9% | 93.9% | 90.3% | 85.1% | 87.0% | 84.1% | 79.7% | 76.1% |
| (2%) + Vanillin (5%) in 70% Ethanol | | | | | | | | | |
| 8% Oil of Anisomeles + 5% Vanillin in 70% | 100% | 96.5% | 90.6% | 89.4% | 80.3% | 75.3% | 77.6% | 70.5% | 72.3% |
| Ethanol | | | | | | | | | |
| 16% Oil of Anisomeles + 4% Refined Extract + | 100% | 100% | 100% | 100% | 100% | 99.1% | 98.9% | 97.4% | 91.1% |
| 5% Vanillin in 70% Ethanol | | | | | | | | | |
| 16% Oil of Anisomeles + 4% Refined Extract + 5% | 100% | 100% | 100% | 100% | 99.7% | 94.5% | 92.3% | 95.6% | 90.5% |
| Vanillin in a formulated cream/gel | | | | | | | | | |
| Placebo (Formulated Cream/Gel Control) | 57.7% | 24.6% | — | — | — | — | — | — | — |

Based on the mosquito repellent activity result of the tested samples (Table 3), the best combination of the oil and the refined/enriched extract was used for the Ticks repellent studies.

### Study Design for Ticks Repellent Testing

The ticks used in this study were Ixodes Ricinus (male, female and nymphs). The tick repellent activity of the tested sample was performed by two different methods. In method 1, the ticks are placed on the lower part of a cylinder ermined of synthetic leather or filter paper, which is treated with the tested substance to test above a line named “crossing line”. The ticks have natural negative geotropically behaviour. The tick will be considered repelled when will walk back or will fall down from the treated area. A replication is considered as a single cylinder. 5 ticks per hour will be tested on each cylinder, the replication will be stopped when the product is no more effective, anyway will last no more than 8 hours. The test can be performed without evaluation of residually (short test), testing just the response of the tick to the freshly applied substance. The ticks are previously checked on an untreated cylinder to be sure they are active.

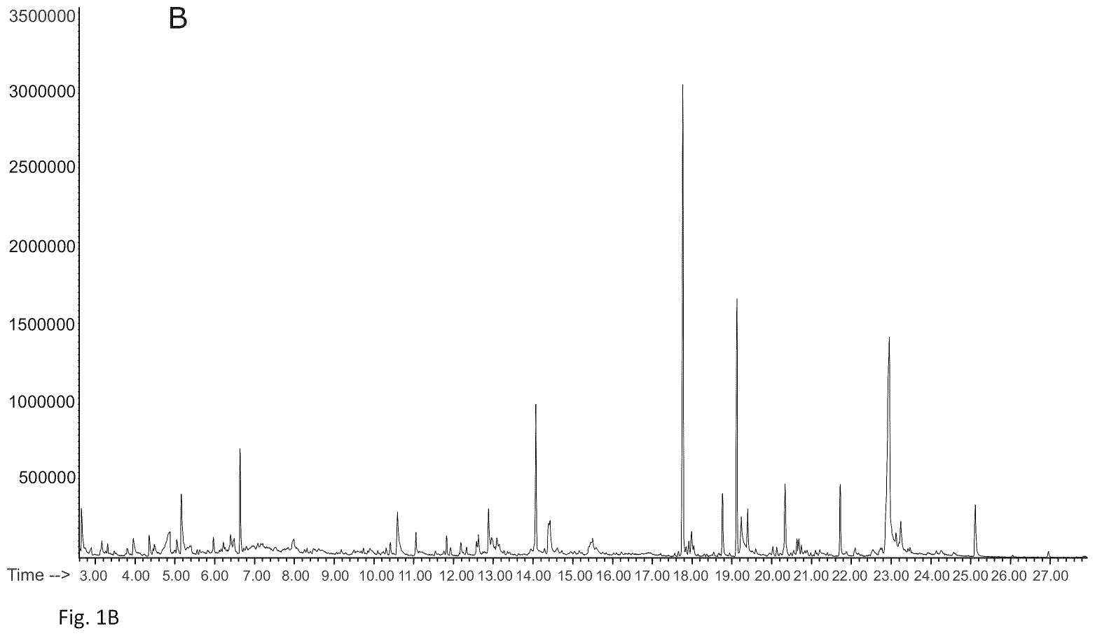

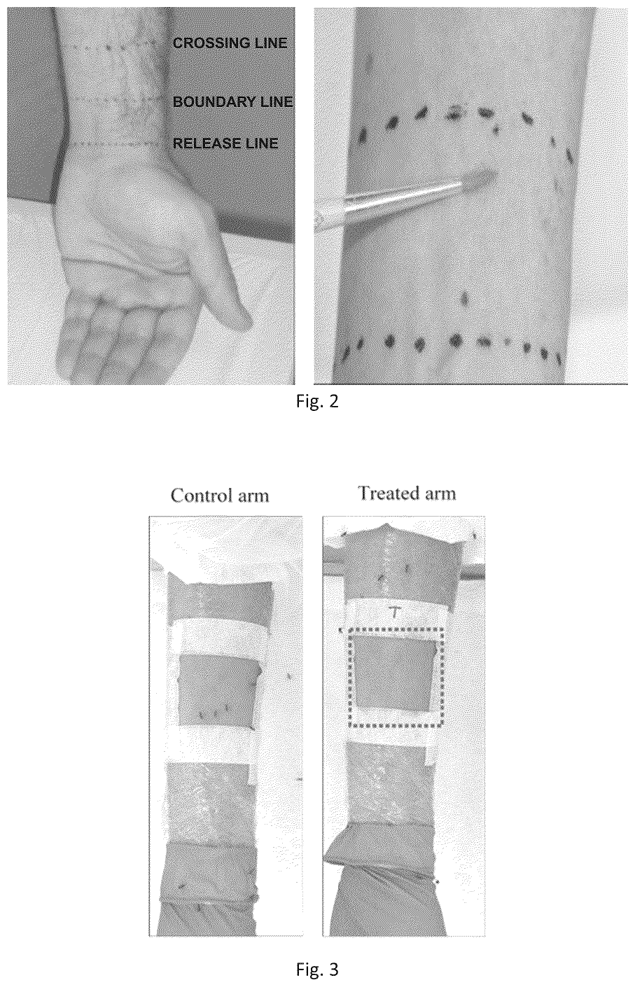

In method 2, the experiment was performed on a human volunteer's forearm. The testing sample was applied according to the dosage of 1 g/600 cm² on a volunteer's forearm and the sample is applied from the wrist to elbow. On the volunteer's forearm three lines are drown (FIG. 2): a “boundary line” at the edge of the treated area close to the wrist, a “release line” 3 cm away from the boundary line outside the treated area towards the hand and a “crossing line” 3 cm away from the boundary line toward the elbow. The same lines are drawn on the control arm. During each trial, the volunteer's control forearm is held at an angle of 300 or more on a flat surface, with the elbow above the wrist. The ticks are placed one-by-one using an artist's paint brush on the release line and then they are gently oriented towards the elbow (FIG. 2).

A tick that moves steadily from the release line across the boundary line and upwards along the volunteer's untreated forearm is considered appropriate for use in the test. The same procedure is performed on the treated forearm; in this case a tick that crosses the crossing line (3 cm into the treated area) within 3 minutes and remains in the treated area for at least one minute is considered “not repelled”. A tick is considered “repelled” when it doesn't cross into the treated area, when it returns to the untreated area within 1 minute or when it lets themselves drop off the skin.

Each trial is repeated at 60 minute intervals for a maximum of 8 hours. Each test consists of 5 replications with different persons of the two sexes in a ratio of 2:3. For each trial 5 fresh ticks are used. All the ticks, both the repelled ones and those that are not repelled, are never used again. The volunteers are not allowed to make use of perfumes, drink alcoholic beverages or coffee nor smoke all day long until the test's conclusion. In order to avoid contaminations of the control forearm, the volunteers dress a TYVK, mono-use sleeve. In between the trials, the sleeve on the control forearm is left donned whereas the treated forearm is left uncovered in order not to hinder the natural process of the repellent sample's evaporation.

### Results of Mosquito and Tick Repellent Tests

The mosquito repellent activity of different combinations of oil of Anisomeles and refined extract with and/or without formulation (Table 3) was tested. It is reported that vanillin has been widely used as a fixative agent for various repellent oils or compounds and it extends the repellency duration of the repellent (Songkro et al, 2012; Misni et al, 2009). Therefore, in the present study, 5% of vanillin have also been tested with our oil and/or refined extract. As shown in Table 3, both the oil of Anisomeles and refined extract showed repellent activity individually as well as combination and their repellency duration extend with vanillin. Also, the repellency is higher in formulation. The mosquito repellent activity of the oil of Anisomeles in 70% ethanol is shown in FIG. 3. The experiment involved applying the oil of Anisomeles (8%) onto two arms, one treated (with the oil on) and the other one untreated (control arm) (FIG. 3). It is clearly seen that the mosquitos, Aedes albopictus, are biting the control arm, as well as the area outside the green square of the treated arm. Whereas no mosquitos are seen within the green square, which was treated with oil.

The repellent activity of some of the major components present in the oil of Anisomeles, hexahydrofarnesyl acetone (HFA), farnesyl acetone (FA), and caryophyllene oxide was tested (Table 4). Farnesyl acetone and caryophyllene oxide were purchased from FisherScientific. HFA was synthesized from FA by hydrogenation using Pd catalyst (Mironenko et al, 2021). The results as revealed in Table 4 show that the compounds FA and HFA both individually and in combination showed efficient repellent activity. At the same time, HFA in combination with FA showed higher percentage of repellent activity compared to HFA alone.

TABLE 4
Mosquito repellent activity of the majority components present in the oil of
Anisomeles

| | Percentage Protection Time | | | | | | | | |
|---|---|---|---|---|---|---|---|---|---|
| Active repellent substances | 0 hr | 1 hr | 2 hr | 3 hr | 4 hr | 5 hr | 6 hr | 7 hr | 8 hr |
| 10% Farnesyl acetone (FA) + | 100% | 100% | 100% | 98.3% | 95.6% | 96.7% | 97.8% | 87.6% | 76.8% |
| 5% Vanillin in 70% | | | | | | | | | |
| Ethanol | | | | | | | | | |
| 20% Farnesyl acetone (FA) + | 100% | 100% | 100% | 100% | 100% | 100% | 100% | 95.3% | 84.9% |
| 5% Vanillin in 70% | | | | | | | | | |
| Ethanol | | | | | | | | | |
| 8% Oil of Anisomeles + | 100% | 100% | 100% | 100% | 100% | 100% | 100% | 100% | 100% |
| 10% Farnesyl acetone | | | | | | | | | |
| (FA) + 5% Vanillin in 70% Ethanol | | | | | | | | | |
| 10% Hexahydro farnesyl | 100% | 100% | 100% | 100% | 100% | 96% | 88% | 72.6% | 77.8% |
| acetone (HFA) + 5% | | | | | | | | | |
| Vanillin in 70% Ethanol | | | | | | | | | |
| 5% HFA + 5% FA + 5% Vanillin | 100% | 100% | 100% | 100% | 97% | 96.6% | 96.7% | 94.3% | 98.1% |
| in 70% Ethanol | | | | | | | | | |

Out of the different combinations tested, we have chosen the best combination as well as only oil of Anisomeles and FA (both individually and in combination) for further repellent activity testing against ticks (Table 5).

TABLE 5
Tick repellent activity of oil of Anisomeles

| | Percentage Protection Time | | | | | | | | |
|---|---|---|---|---|---|---|---|---|---|
| Active repellent substances | 0 hr | 1 hr | 2 hr | 3 hr | 4 hr | 5 hr | 6 hr | 7 hr | 8 hr |
| 16% oil of Anisomeles + 4% Refined extract + 5% | 100% | 100% | 100% | 100% | 100% | 100% | 100% | 100% | 100% |
| Vanillin in 70% Ethanol | | | | | | | | | |
| 10% Farnesyl acetone (FA) + 5% Vanillin in 70% | 100% | 100% | 100% | 100% | 100% | 100% | 100% | 100% | 100% |
| Ethanol | | | | | | | | | |
| 5% HFA + 5% FA + 5% Vanillin in 70% Ethanol | 100% | 100% | 100% | 100% | 100% | 100% | 100% | 100% | 100% |

*Tick species Ixodes ricinus; Number of ticks: 3-5 (male, female and nymph)

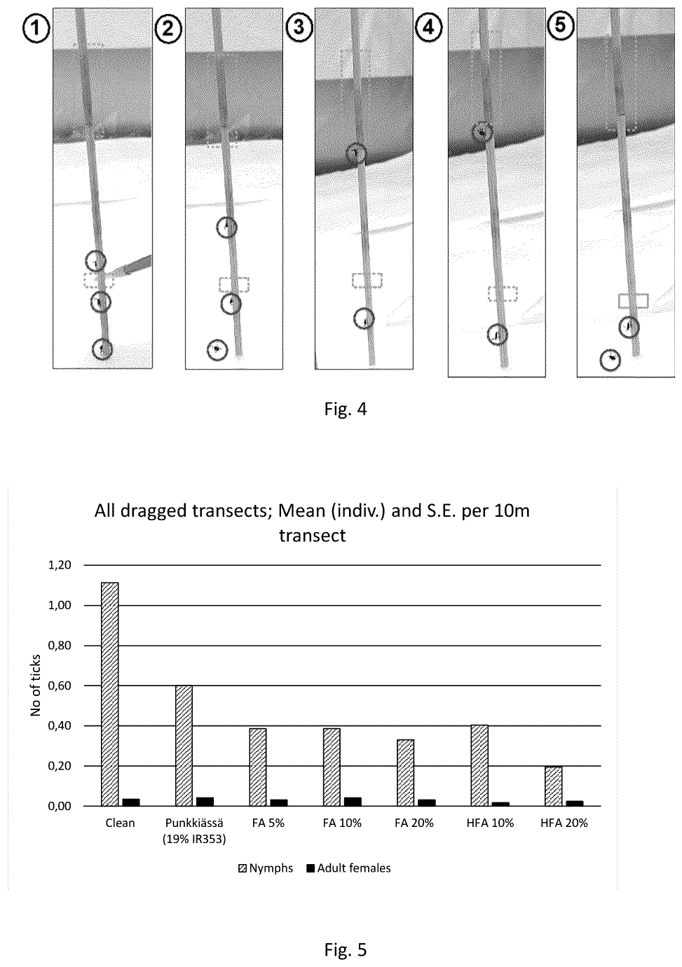

As mentioned above, the testing was done by two different ways. In both ways, the tested samples were found to be effective against tick. FIG. 4 illustrates the efficacy of the 8% oil of Anisomeles (in 70% ethanol) against ticks. Thus, in (1) of FIG. 4 the oil of Anisomeles is applied both at the top and the bottom of the stick. The ticks (Ixodes ricinus) are then encouraged to climb up and down the wooden sticks, starting from the middle part and the bottom part of the stick. In (2) (3) (4) of FIG. 4 the ticks then start climbing along the unaffected parts of the stick, unable to cross the area, which had been applied to with the oil. In (5) of FIG. 4 the tick on the upper part then falls off the stick, whilst the tick at the bottom keeps crawling downwards to avoid the affected area. Thus, the oil of Anisomeles showed very good repellent activity. Other samples were also tested the same way. As shown in Table 5, all the tested samples showed 100% complete protection against ticks (tested up to 8 h). These samples could still be effective for more than 8 h. Caryophyllene oxide was also tested for tick repellent activity but was found to be not very effective.

### Skin Irritation Testing

The dermal application of the oils of Anisomeles was conducted on rabbits to determine the irritation and/or corrosive effect of Anisomeles oil. The animal used in this study were New Zealand white male rabbits. The experiments were performed as per OECD (The organization for economic co-operation and development) guideline no. 404, ‘Acute Dermal Irritation/Corrosion’. The rabbits were housed individually in stainless steel cages. At least 15 air changes per hour were maintained throughout the in-life phase of this study. Standard sterilized rabbit diet was provided ad libitum. Three healthy young adult rabbits were procured from APT Testing & Research Pvt Ltd, Pune, India and were allowed to acclimatize at least for five days prior to the application. During this period, rabbits were observed daily for mortality, morbidity and clinical signs. Approximately 24 h before application, for of all animals was removed by closely clipping the dorsal area of the trunk of the animals. After completion of the acclimatization, healthy rabbits with intact skin were stepwise allocated to initial and confirmatory tests.

A dose of 0.5 mL of oil of Anisomeles was applied to the test site. The test item was applied to ˜6 cm² (3×2 cm) skin area and covered with a gauze patch, which was held with non-irritating tape. The patch was loosely held in contact with the skin using semi-occlusive dressing to avoid ingestion or inhalation of the test item by animal. At the end of the exposure period up to 4 hours, residual test item was removed using water.

Initial test was performed using one animal. Three test patches were applied sequentially at different sites to check for serious skin reactions. The first patch was removed after three minutes, second patch after one hour and third patch after four hours, and the response was graded. For confirmatory test, two additional animals, each with one patch were tested simultaneously with 4 h exposure period, as initial test revealed negative response. The animals were observed up to 72 h after removal of the 4 h patch. Mortality and morbidity were checked twice daily, whereas clinical signs were recorded once daily.

For the initial test, the test site was examined after the patch removal of 3 min and 1 h exposures. All animals were examined for signs of erythema and oedema, and the responses scored at 60 minutes, and then at 24, 48 and 72 hours after patch removal of 4 h exposure. Body weights of animals were recorded on day of application and termination. Body weights were also recorded during acclimation period. This data was not included in study report but maintained in the study file. The dermal irritation scores were evaluated based on scoring of 24 h, 48 h and 72 h skin reactions.

The dermal application study of oil of Anisomeles (both in initial and confirmatory tests) revealed no mortality, morbidity or any abnormal clinical sign in all three animals throughout the study period of four days. The mortality and clinical observation data are presented in Table 6.

TABLE 6
Individual animal mortality and clinical signs

Observation day

| Test | Animal No. | 0 | 1 | 2 | 3 |
|---|---|---|---|---|---|
| Initial | 01 | 1 | 1 | 1 | 1 |
| | 02 | 1 | 1 | 1 | 1 |
| Confirmatory | 03 | 1 | 1 | 1 | 1 |

Key: 1 = Normal.

The dermal reaction data are presented in Table 7. No erythema or oedema was observed at oil of Anisomeles in all three animals till 72 h. The average scoring (of 24 h, 48 h and 72 h) of each of three animals was 0.00.

TABLE 7
Animal dermal irritation/corrosion response in individual animals

| | | | Observation | | | | | |
|---|---|---|---|---|---|---|---|---|
| | | | 3 min | 1 h | | | | |
| | Ani- | | Appli- | Appli- | 4 h | | | |
| | mal | Dermal | cation | cation | Application | | | |
| Test | No. | Reaction | 0 h | 0 h | 1 h | 24 h | 48 h | 72 h |
| Initial | 01 | Erythema | 0 | 0 | 0 | 0 | 0 | 0 |
| | | Oedema | 0 | 0 | 0 | 0 | 0 | 0 |
| Confir- | 02 | Erythema | — | — | 0 | 0 | 0 | 0 |
| matory | | Oedema | — | — | 0 | 0 | 0 | 0 |
| | 03 | Erythema | — | — | 0 | 0 | 0 | 0 |
| | | Oedema | — | — | 0 | 0 | 0 | 0 |

In conclusion, dermal application of oil of Anisomeles to male New Zealand White Rabbit did not result in mortality or any abnormal clinical sign throughout the study period. There were no test item related effects on body weight. Further, it can concluded that oil of Anisomeles was “Non-Irritant” when applied dermally to rabbits

The skin irritation study of the refined or enriched extract from Anisomeles species was done and reported in a co-pending patent application, publication no. WO 2020/254726 A1. Briefly, skin irritation tests in rabbits were performed according to the OECD guidelines and the refined extract was found to be non-toxic and non-irritant.

### Field Testing—Treated Tick Sheet Dragging

Tick-dragging method was adopted to study the effectiveness of the product in repelling ticks in their natural habitat in Ruissalo, Turku. A square of 1 m² cotton sheet was divided in three parallel divisions and the borders were marked with pencil: 100*45 cm division on both sides (A and B) and a 100*10 cm neutral strip in the middle (N). Both A and B were both treated with a solution from a solution test pair (or left untreated for control drags) from that side of the sheet that would face the ground during dragging. The neutral zone was always left untreated. The evenly sprayed solution was let settle on the sheet for ˜15 minutes before the first drag. The sheet was dragged for 10 m with the treated side down with moderate pace in an even, tick-friendly biotope. After every 10 meter drag, the treated side was inspected for Ixodes larvae, nymph forms and adults (female and male). Number of individuals in every (4) form per department (A, B or N) was counted. Every test pair/sheet was dragged 35 times during the same day between 08:00 AM and 02:00 PM. No new solution was added to the sheet during the day. The time of start for every draw was checked. We tested different product types for field studies like FA (5, 10, 20%) and HFA (10 & 20%) and also included a commercial tick repellent (Punkkiassa) as a positive control. Said commercial product is used commonly as a tick repellent in Finland and it contains IR3535 as an active ingredient in a concentration of 19%.

The field study results showed that our product performed with higher efficacy compared to the commercial product. As shown in FIG. 5, the nymphs were the mainly sampled population due to its abundance. They are usually hard to repel and the different products with FA or HFA repelled nymphs very effectively compared to the commercial product. Both FA & HFA repellent ticks efficiently compared to the commercial product and also compared to the clean or untreated sheet. When the FA or HFA concentration was increased to 20% the efficacy was much higher in repelling ticks and solution, containing 20% HFA showed efficient repellent activity compared to solution, containing FA 20%. Vanillin was added at 5% concentration to all the FA & HFA solutions.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in chemical and pharmaceutical industry. Hexahydrofarnesyl acetone (HFA) as well as hexahydrofarnesyl acetone containing Anisomeles oil and enriched oil find use in insect repellent compositions for animals, including humans. HFA, Anisomeles oil and enriched oil find use also in a method of preventing diseases transmitted or caused by insects, in particular ticks and mosquitoes.

The present invention can be further understood with reference to the following paragraphs:
1. An insect repellent composition comprising an effective amount of hexahydrofarnesyl acetone (HFA), HFA related substances, or both, and a delivery vehicle.
2. The composition according to paragraph 1, comprising at least 1% of HFA, HFA related substances or both, typically at least 5%, more typically at least 10% by weight of the composition, and wherein HFA, HFA related substances or both preferably are present in an amount of about 1-50%, preferably 5-50%, such as 5-40%, more preferably 10-50%, such as 10-40%, by weight of the composition.
3. The composition according to paragraph 1 or 2, comprising an effective amount of HFA, which is 1-50%, preferably 5-40%, by weight of the composition.
4. The composition according to paragraph 3, wherein the effective amount of HFA is at least 10% by weight of the composition.
5. The composition according to any one of the preceding paragraphs, wherein the HFA related substances comprise farnesyl acetone in an amount of at least 1%, preferably at least 5%, typically in an amount of 5-40%, preferably about 5-30%, more preferably 5-20%, by weight of the composition.
6. The composition according to paragraph 5, comprising a combined amount of HFA and FA, which is at least 5%, preferably at least 10%, more preferably at least 20% by weight of the composition.
7. The composition according to any one of the preceding paragraphs, comprising HFA, HFA related substances or both, a fixative agent, preferably vanillin, and a delivery vehicle, wherein the delivery vehicle preferably comprises water and at least one aliphatic alcohol.
8. The composition according to any one of the preceding paragraphs, wherein the delivery vehicle is an aqueous aliphatic alcohol or a cream or gel base comprising aqueous aliphatic alcohol, and wherein the composition preferably is a spray, lotion, cream, gel, roll-on or a vaporizer.
9. Use of hexahydrofarnesyl acetone as an insect repellent, preferably for repelling mosquitoes, ticks or both.
10. Use of oil of Anisomeles species as an insect repellent, wherein said oil comprises at least hexahydrofarnesyl acetone (HFA), preferably HFA and HFA related substances.
11. The use according to paragraph 10, wherein the oil of Anisomeles species is used in combination with at least one enriched or refined extract of Anisomeles species as an insect repellent, wherein the enriched/refined extract comprises HFA or HFA related substances.
12. The use according to paragraph 10 or 11, in combination with added hexahydrofarnesyl acetone, farnesyl acetone or both.
13. The use according to any one of paragraphs 10 to 12, wherein the oil, or the combination of oil and enriched extract, optionally combined with added HFA, FA or both, are formulated in an insect repellent composition, which comprises a delivery vehicle.
14. The use according to any one of paragraphs 10 to 13, wherein the oil of Anisomeles species is obtained by a method comprising the steps of extracting plant material of the Anisomeles species by hydrodistillation, collecting the aqueous phase, separating the oil components by using an organic solvent, preferably chloroform, and recovering the oil of Anisomeles.
15. The use according to any one of paragraphs 11 to 14, wherein the enriched or refined extract is obtained by extracting Anisomeles plant material with an alcoholic, for example an aqueous alcoholic, or ether solvent, preferably in the presence of activated carbon or by treating the obtained extract with activated carbon, and wherein the delivery vehicle is at least partly different from the solvent used for extraction of the Anisomeles plant material.
16. The use according to paragraphs 10 to 15, wherein the Anisomeles species is selected from Anisomeles malabarica, Anisomeles indica, Anisomeles ovata, and combinations thereof, preferably Anisomeles malabarica.
17. The use according to any one of paragraphs 9 to 16, wherein HFA, optionally with farnesyl acetone, is present in an amount of at least 1%, preferably at least 5%, such as 5-50%, more preferably 5-40% by weight in an insect repellent composition, which comprises a delivery vehicle.
18. An insect repellent composition comprising an effective amount of oil of Anisomeles species, and a delivery vehicle, wherein said oil comprises hexahydrofarnesyl acetone (HFA), HFA related substances or both.
19. The composition according to paragraph 18, wherein the oil of Anisomeles species is present in an amount of at least about 5%-about 50% by weight of the composition, preferably at least 10%, such as 10-20%, by weight of said composition, and wherein the oil of Anisomeles species has preferably been obtained by a method comprising the steps of extracting plant material of the Anisomeles species by hydrodistillation, collecting the aqueous phase, separating the oil components by using an organic solvent, preferably chloroform, and recovering the oil of Anisomeles.
20. The composition according to paragraph 18 or 19, which further comprises added hexahydrofarnesyl acetone, farnesyl acetone or both.
21. The composition according to paragraph 20, wherein added HFA, added farnesyl acetone or both are present in an amount of at least 1%, preferably at least 5%, such as 5-50%, more preferably 5-40% by weight of the composition.
22. The composition according to any one of paragraphs 18 to 21, comprising an enriched or refined extract from Anisomeles species, preferably from A. malabarica, and wherein said enriched or refined extract preferably is present in an amount of at least 3%, more preferably 3-10%, still more preferably 5-15%, by weight of the composition, and contains about 8 to 10% of plant material/extractives
23. The composition according to any one of paragraphs 18 to 22, wherein the composition comprises 5-50% of oil of Anisomeles and 3-10% of enriched or refined extract from Anisomeles species, calculated by weight of the composition
24. The composition according to any one of paragraphs 18 to 23, wherein the composition comprises 5-50%, preferably 5-40% of oil of Anisomeles and 1-50%, preferably 5-40% of added HFA, FA or both, calculated by weight of the composition.
25. The composition according to any one of paragraphs 18 to 24, wherein the absolute amount of HFA is at least 5%, preferably at least 10%, by weight of the composition.
26. The composition according to any one of paragraphs 18 to 25, wherein the composition further comprises a fixative agent, preferably vanillin, which preferably is present in an amount of about 5% by weight of the composition.
27. The composition according to any of paragraphs 18 to 26 for repelling insects selected from mosquitoes, ticks, fleas, cockroaches, bugs, ants and flies, including deer flies or elk flies, typically mosquitoes and ticks, particularly ticks, more particularly female ticks, male ticks and nymph ticks, still more particularly female ticks and nymph ticks.
28. An article of manufacture that has been treated or impregnated with a composition according to any one of paragraphs 1 to 8 or with a composition according to any one of paragraphs 18 to 27, wherein said article of manufacture is preferably selected from the group consisting of textiles and equipment for humans and animals, such as jackets, sweaters, T-shirts, socks, caps, and trousers; shoes, mosquito nets, dermal wipes, and the like.
29. A method of repelling insects or preventing infections caused or transmitted by insects, wherein the method comprises administering topically on the skin or clothing of a subject an effective amount of an insect repellent composition according to any one of paragraphs 1 to 8 or any one of paragraphs 18 to 27 or wearing or using an article of manufacture according to paragraph 28.

### ACRONYMS LIST

GC-FID gas chromatography with flame ionization detection
GC-MS gas chromatography with mass spectrometer

### CITATION LIST

### Patent Literature

US 2005042244 A1
US 2005129752 A1
WO 2017/081445 A1
WO 2020/254726 A1

### Non Patent Literature

Colucci B.; Müller P. Evaluation of standard field and laboratory methods to compare protection times of the topical repellents PMD and DEET. Scientific reports 8 (2018) 12578.
Demiray, H. et al.: Chemical composition of the essential oil and n-hexane extract of Stachys tmolea subsp. Tmolea Boiss., an endemic species of Turkey, and their mosquitocidal activity against dengue vector Aesdes aegypti. Saudi Pharmaceutical Journal 27 (2019) 877-881.
Govindarajan M.; Rajeswary M.; Veerakumar K.; Muthukumaran U.; Hoti S. L.; Beneli G. Green synthesis and characterization of silver nanoparticles fabricated using Anisomeles indica: mosquitocidal potential against malaria, dengue and Japanese encephalitis vectors. Experimental Parasitology 161 (2016) 40-47.
Jayakumar J.; Elumalai K.; Dalmin G.; Krishnamurthy R. Larvicidal and synergistic activity of Anisomeles malabarica and Phyllanthus emblica against the larvae of common malarial vector, Anopheles stephensi Liston. (Diptera: Culicidae). Discovery 20(2014) 36-41.
Kundu A.; Saha S.; Walia S.; Kour C. Antioxidant and antifungal properties of the essential oil of Anisomeles indica from India. Journal of medicinal plants research 7 (2013) 1774-1779
Liu J-J. et al.: Chemical component and antimicrobial activity of volatile oil of Calycopteris floribunda. J. Cent. South Univ. Technol. (2009) 16, 931-935.
Mironenko R. M.; Saybulina E. R.; Stepanova L. N.; Gulyaeva T. I.; Trenikhin M. V.; Rodygin K. S.; Ananikov V. P. Sustainable hydrogenation of vinyl derivatives using Pd/C catalysts. Catalysts 11 (2021) 179
Misni N.; Sulaiman S.; Othman H.; Omar B. Repellency of essential oil of piper aduncum against Aedes albopictus in the laboratory. Journal of the American Mosquito Control Association 25 (2009) 442-447
Rassem H. H. A.; Nour A. H.; Yunus R. M. Techniques for extraction of essential oil from plants: a review. Australian Journal of Basic and Applied Sciences 10 (2016) 117-127.
Songkro S.; Jenboonlap M.; Boonprasertpon M.; Maneenuan D.; Bouking K.; Kaewnpparat N. Effects of glucam p-20, vanillin, and fixolide on mosquito repellency of citronella oil lotions. Journal of Medical Entomology 49 (2012) 672-677.
Unpaprom Y.; Ramaraj R.; Kadarkarai M. Mosquito Larvicidal Properties of Anisomeles Malabarica (L.) Extracts Against the Malarial Vector, Anopheles Stephensi (Liston). Chiang Mai Journal of Science 42 (2015) 148-155.
Zahir et al. Evaluation of botanical extracts against Haemaphysalis bispinosa Neumann and Hippobosca maculata Leach. Parasitology Research 107 (2010) 585-592.
Yogesh U; Krishnakant P. Chemical Composition and Antibacterial Activity of Essential Oil from Anisomeles Species grown in India. Pharmacognosy Journal 2 (2011) 55-59.

1-18. (canceled)

19. An insect repellent composition comprising an effective amount of oil of Anisomeles species, and a delivery vehicle, wherein said oil comprises hexahydrofarnesyl acetone (HFA).

20. The composition according to claim 19, wherein the oil of Anisomeles species is present in an amount of at least about 5% to about 50% by weight of the composition.

21. The composition according to claim 19, wherein the oil of Anisomeles species has been obtained by a method comprising the steps of extracting plant material of the Anisomeles species by hydrodistillation, collecting the aqueous phase, separating the oil components by using an organic solvent, and recovering the oil of Anisomeles.

22. The composition according to claim 19, wherein the composition further comprises added hexahydrofarnesyl acetone (HFA), added farnesyl acetone, or both.

23. The composition according to claim 22, wherein the added HFA, added farnesyl acetone, or both are present in an amount of at least 1%, by weight of the composition.

24. The composition according to claim 19, further comprising an enriched or refined extract from Anisomeles species from A. malabarica, and wherein said enriched or refined extract is present in an amount of at least 3%, by weight of the composition, and contains about 8 to 10% of plant material/extractives

25. The composition according to claim 24, wherein the composition comprises 5-50% of the oil of Anisomeles and 3-10% of the enriched or refined extract from Anisomeles species, calculated by weight of the composition.

26. The composition according to claim 19, wherein the composition further comprises 5-50% of the oil of Anisomeles and 1-50% of added hexahydrofarnesyl acetone (HFA), added farnesyl acetone (FA), or both, calculated by weight of the composition.

27. The composition according to claim 19, wherein the absolute amount of HFA is at least 5%, by weight of the composition.

28. The composition according to claim 19, wherein the composition further comprises a fixative agent, present in an amount of about 5% by weight of the composition.

29. The composition according to claim 19, wherein the composition is effective for repelling insects selected from mosquitoes, ticks, fleas, cockroaches, bugs, ants, flies, deer flies, elk flies, mosquitoes and ticks.

30. An article of manufacture that has been treated or impregnated with the composition according to claim 19, wherein the article of manufacture is selected from the group consisting of textiles, jackets, sweaters, T-shirts, socks, caps, trousers, shoes, mosquito nets, and dermal wipes.

31. A method of repelling insects or preventing infections caused or transmitted by insects, wherein the method comprises:
administering topically on the skin or clothing of a subject an effective amount of the insect repellent composition according to claim 19.

32-34. (canceled)

35. The composition according to claim 19, wherein the oil of Anisomeles species is present in an amount of 10-20%, by weight of said composition.

36. The composition according to claim 22, wherein the added hexahydrofarnesyl acetone (HFA), added farnesyl acetone, or both are present in an amount of from 5-50%, by weight of the composition.
